(19) United States
(12) Patent Application Publication
(10) Pub. No.: US 2008/0093928 A1
(43) Pub. Date: Apr. 24, 2008

(54) Power outlet control device with USB controller(s)

(75) Inventor: Hsueh Chin Hsieh, Taipei (TW)

Correspondence Address: BACON & THOMAS, PLLC, 625 SLATERS LANE, FOURTH FLOOR, ALEXANDRIA, VA, 22314, US

(73) Assignee: OMEGA TECHNOLOGY OF TAIWAN INC, Taipei County (TW)

(21) Appl. No.: 11/583,080

(22) Filed: Oct. 19, 2006

(51) Int. Cl. H02J 3/14

(52) U.S. Cl. 307/38

(57) ABSTRACT

A Power Outlet Control Device with Serial Bus(es). It is a power socket that detects the working state of Electronic Device(s) through the Serial Bus and turns on or cuts off the power of the Electronic Device(s) according to the working state. The Power Control Socket Device with Serial Bus(es) comprises: a main power socket, connected to AC power; a sub socket; a Serial Bus, to output a data signal; a controller, connected to said Serial Bus and detecting said data signal to generate a control signal; a power switch, connected to said sub socket, said AC power and said control, with said control signal controlling the turning on or cutting off said AC power to said sub socket.

### FIELD OF THE INVENTION

An outlet control device with SERIAL BUS(es), particularly a device that can detect the working state of electronic devices through its built-in SERIAL BUS (s) and switch on or off their power supply accordingly.

### DESCRIPTION OF THE PRIOR ART

As technology continues to progress, the computer has firmly established its status as a permanent presence in either our office or home. No matter at work or in recreation, people need to use computers. However, as general multi-outlet power sockets are often burdened with the supply of power to equipment other than the computer, such as speakers, printers, video displays, scanners and peripheral devices etc., safety problems thus arise. There are now power supply sockets with (on/off) switch on the market (as in FIG. 1) that allow the user to manually switch on off the power supply of the power sockets.

But in advisable computer using codes, when computers are not in use, the power supply should be switched off to prevent the hazard of fire. This, however, is often overlooked by computer users, resulting in not only the waste of energy, but the shortening of service life of equipment, not to mention the possible safety problem regarding to fire. The market is, therefore, in a pressing need for a power supply socket for computers that can automatically switch off the power supply as the computers were shut off.

### BRIEF DESCRIPTION OF THE INVENTION

In view of the above, the inventor has thus come up with the present invention of Power Outlet Control Device with SERIAL BUS(es), which can detect the working state of electronic devices through the built-in SERIAL BUS (es) and switch on or off the power supply to these electric devices accordingly.

The present invention's Power Outlet Control Device with SERIAL BUS(es) comprises: a power socket connected to an AC power source, a sub socket, a SERIAL BUS that outputs data signals, a controller, connected to the SERIAL BUS, that detects the data signals to generate control signals, a power switch, connected to the sub socked, the AC power source, and the controller, with the control signals controlling the power switch to connect or cut off the power from the AC source to the sub socket.

The SERIAL BUS and the Main Power Socket are connected to an electronic device, with the SERIAL BUS receiving data signals from the electronic device and the main power socket supplying AC power to the electronic device.

To let the examiners further understand the technical features of the present invention, the inventor will further describe the present invention in the following with illustrations. However, it is to be understood that the illustrations may serve only to highlight, rather than to limit, the scope of the present invention.

### DESCRIPTION OF THE PREFERRED EMBODIMENT

Please refer to FIG. 2. FIG. 2 shows the exterior features of the present invention. The present invention's Power Outlet Control Device with SERIAL BUS(es) 2 is connected to a main power supply socket 21, a slave power socket 22, and a SERIAL BUS 23. Through the SERIAL BUS 23, the present invention is connected to the Electronic Device 3, detecting the working status of the Electronic Device 3 by way of serial control. On the other hand, the present invention also switches on/off the power to the SERIAL BUS-attached slave power socket 22 according to the working state of the Electronic Device 3.

In practice, the present invention's slave power socket 22 can be expanded into a plurality of parallel slave power socket 22 for a plurality of power consumption devices. In other applications, the present invention can be used in line with traditional power sockets in lieu of the expansion of slave power socket 22, example as illustrated in FIG. 3.

Please refer to FIG. 4. FIG. 4 shows the circuitry diagram of the present invention. The Power Outlet Control Device with SERIAL BUS(es) 2 of the present invention comprises: a main power supply socket 21, a slave power socket 22, a SERIAL BUS 23, a controller 24, a power switch 25, a varistor protector 26, and a power indicator light circuit 27.

In FIG. 4, the varistor protector 26 is connected to the power supply socket 21. The power switch 25 and the power indicator light circuit 27 are connected to an AC power source. When an AC current is suddenly conducted into the present invention, voltage or current surge may occur and damage the electronic components of the present invention. The varistor protector 26 thus serves to protect the present invention's electronic components against sudden surge of voltage or current.

The main power socket 21 is connected to the above varistor protector 26. Through the main power socket 21, AC power is supplied to the aforesaid Electronic Device 3 (please refer to FIG. 2), which can be a personal computer.

The power indicator light circuit 27 is connected to the aforesaid varistor protector 26. Through the varistor protector 26, AC power is supplied to the power indicator light circuit 27, which tells the user the working state of the AC power.

The Serial Bus 23 as used in the present invention is connected to the Electronic Device 3 (please refer to FIG. 2). The SERIAL BUS 23 can be a USB, a RS-232 SERIAL BUS, a RS-485 SERIAL BUS, a RS-422 SERIAL BUS, or an IEEE-1394 SERIAL BUS. To save time and space, we use the USB for illustration in the following part of “description of the preferred embodiment”.

The Electronic Device 3 sends a data signal DS to the Serial Bus 23, while the controller 24, connected to the SERIAL BUS 23, regularly monitors the data signal DS and then outputs a control signal. The power switch 25 is a relay which comprises a magnetic coil (not marked) and a switch contact point (not marked). The magnetic coil is connected to the controller 24 and is controlled by the control signal CS of the switch contact point, which, through the induction or elimination of magnetic field, controls the switching-on/off of the contact point. The switch contact point is connected to the sub socket and serves to control the AC power flowing through the varistor protector 26, in order to turn on or cut off the power supply to the slave power socket 22.

Please refer to FIG. 4 and FIG. 5. The two diagrams illustrate the circuitry of the present invention. The controller 24 comprises, among others, a control chip U1 and an on/off switch Q1. The above control chip U1 is a USB serial control chip, connected to the above mentioned Serial Bus 23. The on/off switch Q1 is a p-channel FET or a n-channel FET (field effect transistor).

As shown in FIG. 5, the Serial Bus 23 is a USB with two power cords (VCC, GND) and two data cables (D+, D−). When the Serial Bus 23 is connected to a computer, the control chip U1 will, at regular intervals, detect data signals DS transmitted from the data cable D+ of the Serial Bus 23. The control chip U1 will compare and compute the aforesaid data signal DS, and then output, from the data output terminal, control signals CS that control the on/off of the switch Q1.

When the on/off switch Q1 is in the “on” position, the controller 24 will usher in a driving power VCC from the aforesaid Serial Bus 23 to the aforesaid power switch 25's magnetic coil MS, exciting a magnetic field around it. The excited electro-magnetic coil MS keeps the switch contact point in power-on state, while the AC power from the varistor protector 26 is being conducted to the slave power socket 22 to supply power to all the power-consuming devices connected to the slave power socket 22.

On the other hand, when the on/off switch Q1 is in the “off” position, the controller 24 will cut off the driving power VCC from Serial Bus 23 to the power switch's electro-magnetic coil MS, causing the electro-magnetic coil MS to lose the magnetic field. The demagnetized electro-magnetic coil MS will keep the switch's contact point in the “off” position that the AC power from the varistor protector 26 stops flowing to the slave power socket 22 and the power supply to all the power-consuming devices connected to the slave power socket 22 is cut off.

Again, please refer to FIG. 5. Through the varistor protector 26 and via the main power socket, the AC power is supplied to the electronic device 3 (*please refer to FIG. 2), and to the power indication light circuit 27.

In actual application, the present invention's Power Outlet Control Device with USB Controller(s) provides at least a Serial Bus 23 to be connected to a computer, while a main power socket 22 provides power supply to the computer, and a sub power socket supplies power to other power-consumption devices. When the computer is turned on, the computer will, through the data cable of the Serial Bus 23, detect the present invention and, recognizing its existence, consider it a HID (Human Interface Device) to be supported.

At the same time when the computer is switched on, the present invention will detect machine-on signals through the data cable of the Serial Bus 23, and turn on the power of the slave power socket 22 according to the above machine-on signals. In the reverse process, when the computer is switched off, the present invention will detect machine-off signals through the data cable of the Serial Bus 23, and cut off the power of the slave power socket 22 according to the above machine-on signals. This will not only reduce energy waste, but prolong the service life of the power consumption devices while making the use of electricity safer.

Besides, as the power consumption devices on the sub socket may need more time to complete the jobs in execution, the present invention can also be set to delay cutting off the power of the slave power socket 22, after receiving the machine-off signals.

Furthermore, the present invention can also make use of the transmission cable of a Serial Bus or some Wireless Serial Bus technology to detect the data signals transmitted by the computer.

In summary, the underlying principle of the present invention of Power Outlet Control Device with SERIAL BUS(es) is that the present invention 2 is first connected to a computer via a Serial Bus 23, and it then detects data signals from an Electronic Device 3. The controller will, after comparing and computing, output control signals to set on or cut off the power of slave power socket 22. As such, the present invention of Power Outlet Control Device with SERIAL BUS(es) is a safety-ensuring application that can cut off power supply as the computer is shut off, meeting a pertinent need of people.

As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

### BRIEF DESCRIPTION OF THE DRAWINGS

FIG. 1 shows the outlook of a prior art power socket.

FIG. 2 shows a picture of the present invention connected to an electronic device.

FIG. 3 shows another picture of the present invention connected to an electronic device.

FIG. 4 illustrates the circuit diagram of the present invention.

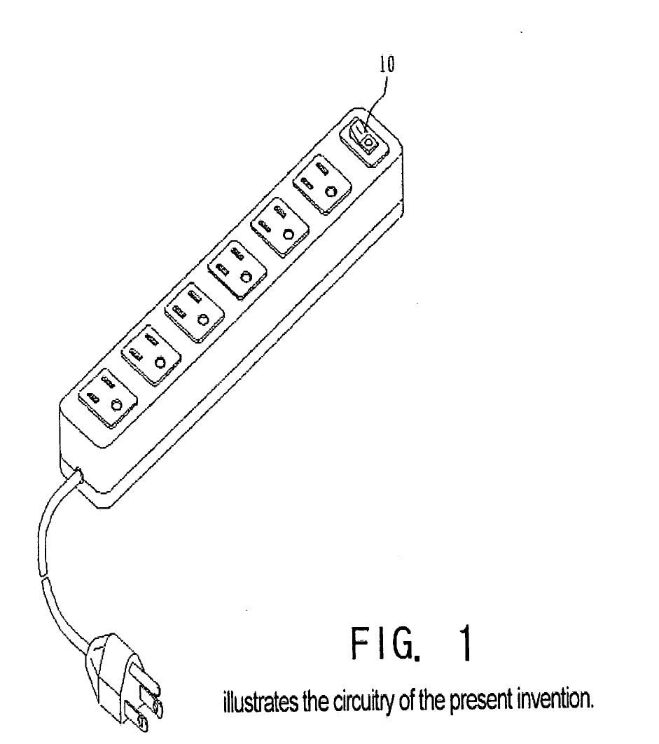

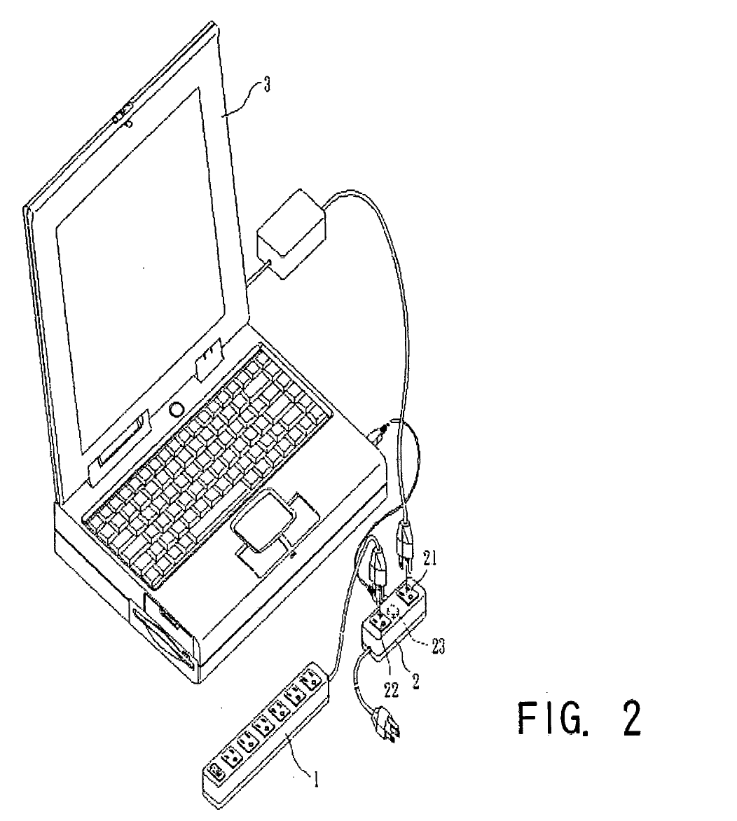

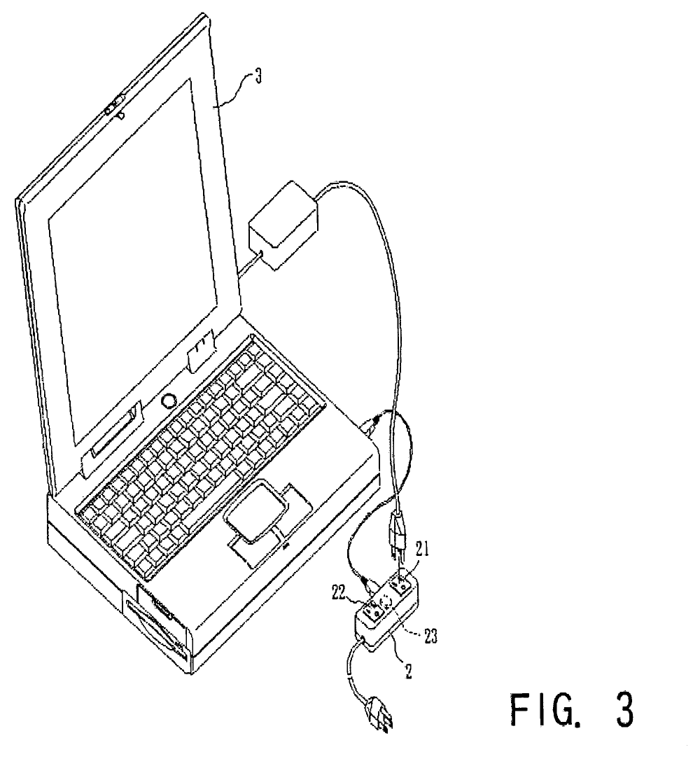

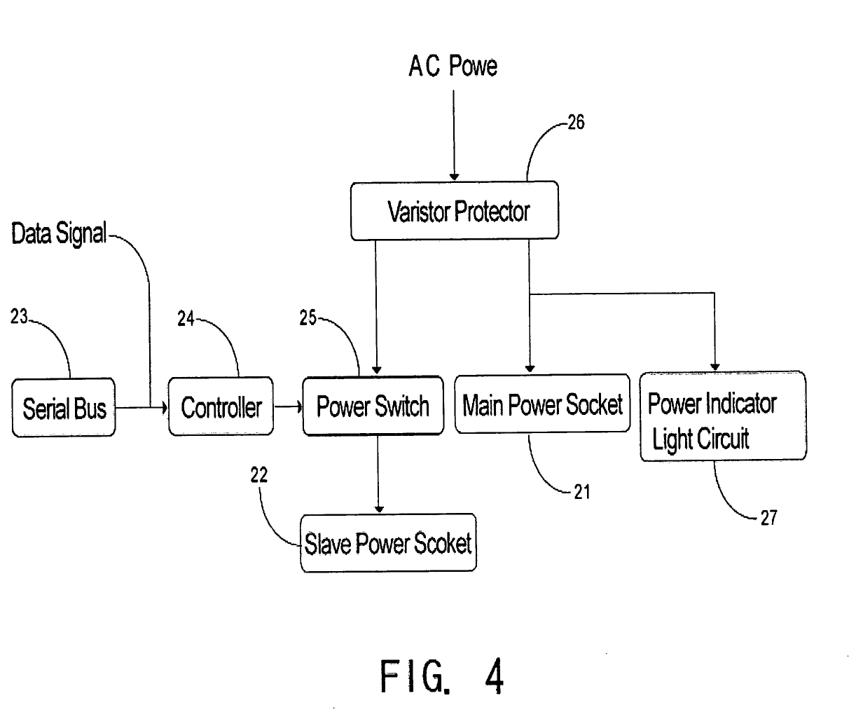

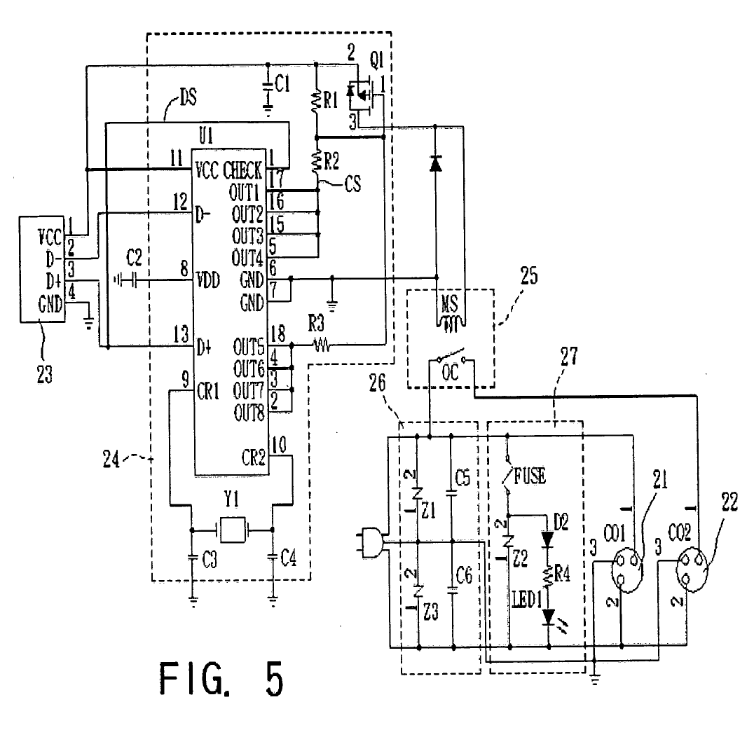

What is claimed:

1. A Power Outlet Control Device with Serial Bus(es) comprising:
a main power socket, connected to AC power;
a sub socket;
a Serial Bus, to output a data signal;
a controller, connected to said Serial Bus and detecting said data signal to generate a control signal;
a power switch, connected to said sub socket, said AC power and said control, with said control signal controlling the turning on or cutting off said AC power to said sub socket.

2. The Power Outlet Control Device with Serial Bus(es) as in claim 1, wherein said Serial Bus is a USB.

3. The Power Outlet Control Device with Serial Bus(es) as in claim 1, wherein said Serial Bus is a RS-232 Serial Bus, a RS-485 Serial Bus, a RS-422 Serial Bus, or an IEEE-1394 Serial Bus

4. The Power Outlet Control Device with Serial Bus(es) as in claim 1, wherein said Serial Bus and said main power socket can be connected to an Electronic Device, with said Serial Bus receiving said data signals from said Electronic Device, and said main power socket supplying said AC power to said Electronic Device.

5. The Power Outlet Control Device with Serial Bus(es) as in claim 4, wherein said Electronic Device is a computer.

6. The Power Outlet Control Device with Serial Bus(es) as in claim 1, wherein said controller comprises:
a control chip, connected to said Serial Bus and outputting said control signal,
an on/off switch, connected to said control chip and said Serial Bus

7. The Power Outlet Control Device with Serial Bus(es) as in claim 6, wherein said on/off switch is a p-channel FET (field effect transistor).

8. The Power Outlet Control Device with Serial Bus(es) as in claim 6, wherein said on/off switch is a n-channel FET (field effect transistor).

9. The Power Outlet Control Device with Serial Bus(es) as in claim 1, wherein said device further comprises a surge protector connected to said AC power, said main power socket and said power switch.

10. The Power Outlet Control Device with Serial Bus(es) as in claim 9, wherein said device further comprises a power indicator light circuit connected to said surge protector.

11. The Power Outlet Control Device with Serial Bus(es) as in claim 1, wherein said power switch is a relay.

12. The Power Outlet Control Device with Serial Bus(es) as in claim 1, wherein said Serial Bus is a wireless Serial Bus.
